(19) United States
(12) Patent Application Publication
(10) Pub. No.: US 2007/0026215 A1
(43) Pub. Date: Feb. 1, 2007

(54) Process for forming fiber-containing articles such as annular or ellipsoidal preforms

(75) Inventors: Alain Bruyere, Las Avenieres (FR); Jean Benoit Thiel, La Tour du Pin (FR)

Correspondence Address: WITHERS & KEYS, LLC, P. O. BOX 2049, MCDONOUGH, GA, 30253, US

(73) Assignee: Hexcel Reinforcements

(21) Appl. No.: 11/495,224

(22) Filed: Jul. 28, 2006

(30) Foreign Application Priority Data
Jul. 29, 2005 (FR) 0508137

(51) Int. Cl. D04H 3/04; B32B 27/12; B32B 27/04

(52) U.S. Cl. 428/300.7; 28/100

(57) ABSTRACT

A process for placing at least one fiber element (11₁) on a surface (S) is disclosed, wherein the fiber element (11₁) is deposited on the surface (S) and is bound to at least one part of the surface and a width (l) of the deposited fiber element (11₁) varies longitudinally. Preforms containing one superimposition of several fibrous sheets extending in different directions and bound with each other are disclosed, wherein at least one of the fibrous sheets contains at least one fiber element whose width varies longitudinally.

### TECHNICAL FIELD

The present invention relates to composite preforms. The present invention further relates to processes for placing fiber elements along a surface so as to extend in non-parallel directions. Such processes are particularly adapted for use in the formation of preforms, such as annular or ellipsoidal preforms.

### BACKGROUND

The fabrication of composite parts or items containing one or more fibrous reinforcements on one hand and a thermoplastic or thermohardenable (i.e., thermosettable) resin matrix on the other hand may be accomplished, for example, by Resin Transfer Molding (RTM) techniques. RTM consists of two stages: (i) fabricating a fiber preform in the shape of the desired finished item, and (ii) impregnating the preform with a thermoplastic or thermohardenable resin. The resin is injected or infused by aspiration and then thermocompressed to harden the resin after polymerization.

Preforms generally contain several superimposed sheets of fiber elements bound to each other by a binder in order to provide cohesion of the preform components and to allow handling of the preform. The fiber elements can be either strands or cables, depending on the number of filaments or fibers. Most often, preforms comprise superimposed unidirectional sheets such that the fiber elements are stretched parallel to each other in each of the sheets with the various unidirectional sheets extending in different directions.

Notably, for applications in the aeronautic, aerospace, and automobile domains, it is sometimes necessary to form performs having at least one portion which has an annular, an ellipsoidal, or a truncated cone shape such as in the construction of frames, windows, nozzles, or jet inlets. In order to fabricate and obtain satisfactory mechanical properties for such preforms, whose shape follows at least one curved longitudinal generator line, it is necessary to place fiber element sheets such that the fiber elements are not parallel to the curved generator line. It is very difficult to produce sheets that provide a homogeneous covering without voids using this process. Indeed, the resulting mechanical properties are not satisfactory if the radial sheet does not cover the entire surface of the preform.

### SUMMARY

The present invention is directed to a new process for placing fiber elements along a surface so as to address the above-described problem associated with known methods of forming preforms having at least one portion which has an annular, an ellipsoidal, or a truncated cone shape. The process allows the creation of smooth surface sheets without irregularities such as holes or voids. In particular, the present invention provides a process for fabricating sheets of non-parallel fiber elements suitable for use in the formation of, for example, annular or ellipsoidal preforms so as to make it possible to obtain an absence of voids or defects in the preform.

The present invention is further directed to the resulting preforms and composite parts. The present invention is also directed to a device adapted to implement the disclosed process and form the disclosed preforms.

In one exemplary embodiment, the present invention is directed to a process for placing at least one fiber element on a surface, wherein the fiber element is deposited on the surface and is bound to at least a portion of the surface such that the width of the deposited fiber element varies longitudinally.

In preferred embodiments of the present invention, the disclosed process includes one or more of the following characteristics when they are not mutually exclusive:

a number of fiber elements deposited in non-parallel directions, varying the width of each of the fiber elements;

a number of fiber elements deposited in convergent directions, decreasing the width of each of the fiber elements in the direction of the convergence; preferably decreasing the width of the fiber elements proportionally to the distance separating the middle fibers of two consecutive fiber elements;

the surface on which the fiber elements are deposited extends longitudinally along a curved generator line, and the fiber elements are deposited to be secant to the longitudinal generator line (L), each fiber element forming an identical non-zero angle at its point of intersection with the longitudinal generator line (L), and preferably with the fiber elements forming an angle of 90°, +60°, −60°, +45° or −45° with the longitudinal generator line (L);

the fiber elements are deposited so that no space or void exists between two consecutive fiber elements deposited on the surface;

the fiber elements are deposited in the form of segments adjacent along their entire length;

the surface on which the fiber elements are deposited has an annular shape;

the material of the fiber elements is selected from carbon, ceramics, glasses, or aramids;

the fiber elements are continuous strands;

the fiber elements are continuous strands composed of a set of 3000 to 24000 filaments; and

the fiber elements are bound to the surface by a chemical binder.

In another exemplary embodiment, the process of the present invention relates to the fabrication of a perform, wherein the process comprises the steps of (i) superimposing several fibrous sheets extending in different directions, and (ii) binding together the superimposed sheets, wherein at least one portion of one of the fibrous sheets is fabricated by the process defined above.

The present invention also relates to preforms comprising a superimposition of several fibrous sheets extending in different directions and bound together, wherein at least one fibrous sheet contains at least one fiber element whose width varies longitudinally. The preferred characteristics of the above-described process also apply to preforms of the present invention.

Lastly, the present invention relates to a device for placing at least one fiber element on a surface, wherein the device includes means for manipulating and advancing a fiber element, means that make it possible to vary the width of the fiber element in its longitudinal direction, and means to deposit the fiber element in a desired direction.

### BRIEF DESCRIPTION OF THE FIGURES

The present invention will now be described in detail by referring to the appended figures.

FIG. 1 illustrates one exemplary method of performing a process according to the present invention; and

FIG. 2 is a frontal view of a device component for controlling the width of a fiber element according to the present invention.

### DETAILED DESCRIPTION

In accordance with the present invention, the width of a fiber element may be varied, thus obtaining a covering adapted to the surface on which the fiber element is deposited, even when the surface has a complex shape. The width of the fiber element may be varied by spreading or compressing the fiber element without cutting the fiber element. The width may be modified while maintaining the integrity of the fiber element, that is, without removing any portion of the fiber element and while maintaining a constant number of filaments in the fiber element.

In accordance with the present invention, a sheet of fiber elements having homogeneous fiber coverage is obtained by varying the width of the deposited fiber element or elements. In order to obtain continuous homogeneous fiber coverage of the surface on which the fiber elements are deposited, the present invention associates a deposit of neighboring fiber elements extending into convergent directions to a reduction in the width of the fiber elements in the direction of the convergence.

In accordance with the present invention, a fiber element is understood to be a set of filaments or fibers. The fiber element is a unit and does not comprise a set of strands or cables. Conventionally, a cable contains a larger number of filaments than a strand. Fiber elements used as part of the present invention are preferably of a material selected among carbon, ceramics, glasses, or aramids, with carbon being particularly preferred. The usable ceramics are notably silicon carbide and refractory oxides, such as alumina and zirconia. A strand generally contains 3,000 to 80,000 filaments, and preferably 12,000 to 24,000 filaments. In the case of carbon, a fiber element which contains more than 50,000 (50K) filaments is generally referred to as a “cable” whereas a carbon “strand” is a fiber element containing at most 24,000 (24K) filaments. Thus, there is no clear delineation between strands and cables, particularly since any delineation would depend on the constituent material. In a particularly preferred embodiment, the fiber elements of the present invention comprise 3 to 24K carbon strands. Constituent fibers can be discontinuous, cracked, or preferably continuous. Fiber elements generally present a parallelepiped transversal cross section, and therefore a certain width and thickness. The fiber elements are usually qualified as flat strands or cables. As an example, a 3K strand generally has a width of 1 to 3 mm, a 12K strand has a width of 3 to 8 mm, and a 24K strand has a width of 5 to 12 mm. A strand of 12,000 to 24,000 filaments will therefore most often have a width of 1 to 12 mm.

Fiber elements of this type are generally sold as spools of a certain width. Several methods are available to increase or reduce the width of a fiber element. Fiber element width can be increased by spreading the filaments, for example, by passage the fiber element over circular bars, or by vibration techniques. See, for example, International Patent Publication WO 98/44183, assigned to SOCIETE NATIONALE D'ETUDE ET DE CONSTRUCTION DE MOTEURS D'AVIATION (SNECMA) (Paris, France) and Hexcel Fabrics (Villeurbanne Cedex, France), which presents several techniques for cable spreading. It is also possible to reduce the width of a strand by passing the strand between two constrained surfaces.

In accordance with the present invention, the middle fiber of each fiber element corresponds to an imaginary line stretching along the fiber element equidistant from its edges. The middle fiber can also be defined as the geometric locus of the intersections of the transversal cross sections of the fiber element.

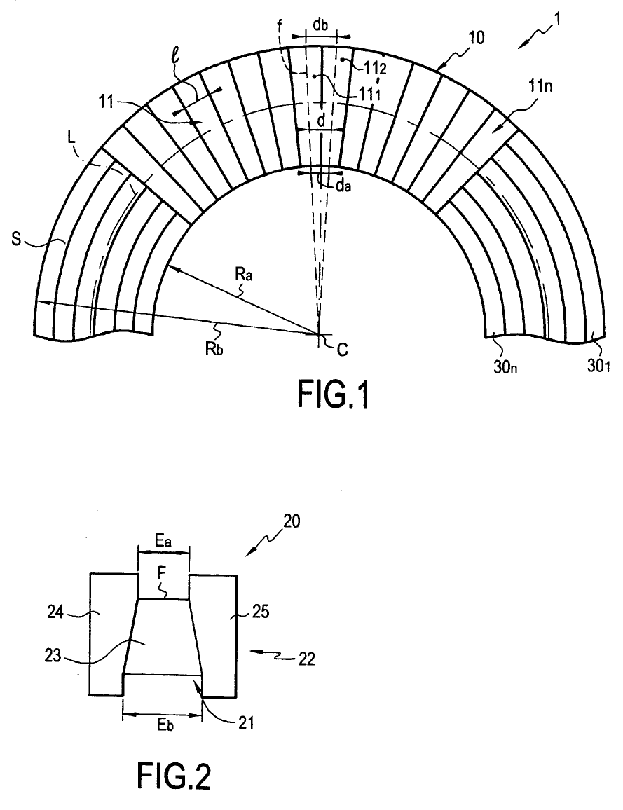

In accordance with the present invention, the lines of curvature are the surface lines on which the fiber element or elements are deposited, and whose geodesic torsion is zero. Thus, two families of lines of curvature formed by meridians and parallels exist for a surface of revolution, and two families of lines of curvature, which are the generatrices (i.e., straight lines) and their orthogonal trajectories, also exist for a developable surface. In the present invention, the median of the parallels in the first case, and the median of the generatrices in the second case is called a longitudinal generator line (L) (see, for example, longitudinal generator line L in FIG. 1).

In accordance with the present invention, at least one fiber element is deposited such that the width of the fiber element is variable along its length. The width of the fiber element is measured on the surface onto which the fiber element is deposited, transversally to the middle fiber of the fiber element.

This can be an advantage, for example, when the fiber element must be deposited on a surface in which a cavity has been prepared, and the fiber element must be deposited in the cavity.

An exemplary process according to the present invention is particularly adapted to be implemented in the construction of preforms. In the automobile or aeronautics industry, for example, it is often necessary to fabricate preforms in which at least one portion of the surface extends along a curved longitudinal generator line L on which the longitudinal lines of curvature do not have a constant radius of curvature during a displacement transversal to the curved longitudinal generator line. In the following description, such surfaces will be referred to as “curved surfaces” such as surfaces on at least one annular, ellipsoidal, or truncated cone portion. To fabricate certain preforms, of which at least a portion of a surface S is curved, and to obtain satisfactory mechanical properties, typically at least one sheet 10 of fiber elements 11₁ to 11ₙ is deposited so as to extend along a non-zero angle with respect to the longitudinal generator line L. In an exemplary embodiment illustrated in FIG. 1, which represents a portion of an annular surface, fiber elements 11₁ to 11ₙ form a 90° angle with the longitudinal generator line L, although fiber elements 11₁ to 11ₙ could alternatively form an angle of 60° or of 45°, for example. Because the longitudinal generator line L of the deposition surface is curved, fiber elements 11₁ to 11ₙ locally secant at an angle essentially identical to line L, are therefore not parallel, but convergent toward the portion of the surface presenting the smallest radius of curvature Rₐ, as illustrated in FIG. 1.

In the present invention, the deposited fiber elements have a width that varies, preferably regularly, along the length of the fiber element. The variation in the width of the fiber elements 11₁ to 11ₙ permits compensation for a changing distance d between adjacent middle fibers 12. Fiber elements 11 are deposited so that middle fibers 12 of two consecutive fiber elements 11 converge. Fiber elements 11 are deposited with a width l, which extends parallel to surface S onto which fiber elements 11 are deposited and which increases along the length of the strand in the direction of convergence. In each sheet that constitutes a preform, the fiber elements are deposited one next to another so as to preferably cover the entire surface onto which they are deposited. Neighboring fiber elements 11₁ to 11ₙ are preferably deposited side by side with the least amount of space possible between two consecutive fiber elements 11 and/or the least possible overlap. The process according to the present invention makes it possible to maintain a very regular surface for the fibrous sheet produced, while limiting losses of material.

In the exemplary embodiment illustrated in FIG. 1, fiber elements 11 are transversal and cross longitudinal generator line L at a right angle. More precisely, the line or middle fiber 12 of a given fiber element 11 is orthogonal to a tangent of longitudinal generator line L at their point of intersection. In the case of an annular preform as shown in FIG. 1, middle fiber 12 of each fiber element 11 essentially coincides with a radius of a ring (i.e., circle) and therefore passes through the center C of the ring. In the illustrated embodiment, width l of each fiber element 11 increases during a radial displacement from a portion of the surface with the smallest radius of curvature Rₐ to a portion of the surface with the largest radius of curvature R_{b}. In addition, advantageously width l of fiber elements 11 decreases proportionally to distance d separating middle fibers 12 of two consecutive fiber elements 11. A distance d_{b} measured from an outer edge of an annular surface corresponding to radius of curvature R_{b}, is greater than a distance dₐ measured at an inside edge of an annular surface corresponding to radius of curvature Rₐ. In order to assure complete coverage of the surface to be covered, transversal fiber elements 11 are preferably deposited side by side and adjacent to one another over their entire length.

In the case of an annular preform, transversal fiber elements 11 are deposited so that their middle fibers 12 extend radially on the annular surface. In order to deposit a strand with a given initial width l along a radial direction on a circular surface with an internal radius Rₐ and an external radius R_{b} so as to produce a homogeneous fibrous sheet, the number of strands to be deposited (nbrF) on the circular surface is calculated by dividing the length of the circumference arc (i.e., (α)*R, wherein a represents the angle, in radians, from a circle center to arc ends, and R represents the circle radius, which varies from Rₐ to R_{b}) by the number of strands, or:
l=(α)*R/(nbrF).

In addition, if the deposition at the external diameter Rb is to remain homogeneous, the width l of the strands will be varied in direct proportion to the radius of curvature. If fiber elements are deposited on an annular surface, the fiber elements will preferably appear as segments of identical dimensions, as illustrated in FIG. 1.

As in the illustrated embodiment, for an annular surface, the width of the fiber elements will be modified in the same manner for all of the fiber elements. In other embodiments, it is possible to modify the width for each individual fiber element according to different amplitudes and/or directions.

A fiber element will typically have a constant width when it leaves the spool. The width of the fiber element is generally modified before being deposited on a given surface. Before being deposited, it is therefore necessary to pass the fiber element or elements through a device 20 that makes it possible to vary the widths of fiber elements in the longitudinal direction. The width along the fiber element can be varied before deposition by passing the fiber element through a peripheral throat 21 formed in a cylindrical element 22, such that the width of the channel increases from value Eₐ to value E_{b} with a displacement inside throat 21 around cylindrical element 22 of over half of the circumference of the cylinder, then the width of the channel decreases from value Eₐ to value E_{b} with a displacement over the other half of the circumference of the cylinder. It is equally possible to vary the width of the fiber element up to an intermediate value included between these two values (e.g., values Eₐ and E_{b}) as a function of the rotation applied to cylindrical element 22. The width of the fiber element before passing through device 20 will typically correspond, for example, to a width of the maximum spreading value E_{b}.

As illustrated in FIG. 2, for example, device 20 may be a cylindrical bar 23 delimited by two discs 24 and 25 of variable thickness. In this exemplary embodiment, discs 24 and 25 provide the side walls of throat 21, which constitutes a channel of variable width for a fiber element. The full assembly (e.g., device 20) is rotated around an axis of cylindrical element 22. The fiber element is then fed so as to arrive flat and perpendicular to the axis of cylindrical element 22, meaning that the fiber element arrives tangentially to cylindrical bar 23 with its width parallel to cylindrical bar 23. The fiber element emerges, for example, after having performed essentially a half-turn or a quarter turn around the rotating cylindrical element 22. The rotation speed of cylindrical element 22 is adjusted as a function of the feeding rate of the fiber element. In general, the fiber element is cut on exit from device 20 so as to obtain a segment of fiber element having a desired length. By synchronizing the advancing rate of a fiber element with the rotation speed of cylindrical bar 23, it is possible to obtain a strand segment of desired length, where the fiber element's width increases regularly from value Eₐ to value E_{b}, or decreases from value E_{b} to value Eₐ. It is also possible to obtain a strand segment of desired length whose width varies between Eₐ and E_{b}.

If multiple fiber elements, typically in the form of fiber segments, are to be deposited, each segment may be deposited either successively or simultaneously. In order to form a fibrous sheet, a number of fiber elements are deposited side by side. As illustrated in FIG. 1, segments are advantageously deposited so as to cover the whole surface on which they are deposited, as well as extend in convergent directions. The variation in the width of the fiber elements deposited in a convergent direction enables the segments to be placed exactly edge to edge. These segments can be derived from the same fiber element or from different fiber elements.

The fiber elements can be deposited in any appropriate manner, manually or by an automatic device. The fiber elements are deposited in the form of segments of increasing (or decreasing) width. According to one exemplary fabrication method, fiber element segments are fed and deposited on a moving surface while the moving surface is progressively moved along its longitudinal generator line (L). In the case of an annular or ellipsoidal surface, displacement of the deposition surface is obtained by rotation around its axis, with a rotation pace corresponding to the width of the deposited segments.

In the fabrication of preforms, sheets of fiber elements of variable width are deposited either on a support or mold surface, or on an anterior sheet of fiber elements extending, for example, along the longitudinal generator line (L) of the surface. In general, several sheets of fiber elements extending in different directions are associated with each other. Each of the sheets can be bound to the surface on which it is deposited by means of a variety of techniques, such as described in French Patent Application FR 2 853 914 assigned to Hexcel Fabrics (Villeurbanne Cedex, France).

Adhesion of the fiber elements to the surface on which they are deposited can be accomplished by means of a chemical binder deposited previously on the surface, or deposited concurrently with the deposition of the fiber elements. Generally in a preform, the weight percentage of chemical binder with respect to the total weight of the preform (total weight of the preform is equal to the weight of the fiber elements plus the chemical binder) varies from 0.1 to 25% and advantageously from 3 to 10%. As known in the art, it may be necessary to activate the binder by thermal energy or other means. Suitable hardeners include adhesive agents and thermoplastic or thermohardenable (i.e., thermosettable) powders or resins. In addition, hybrid fiber element may be formed by using a binder intimately associated with the fiber element by powdering or coating, or with binder strands. Additional information about these techniques may be found in French Patent Application FR 2 853 914 referred to above.

The ends of fiber element segments 11 can also be attached by thermal adhesion along one or both edges of the curved surface, for example, by means of an adhesive strip placed on those edges.

Of course, the process according to the present invention can also be implemented to fabricate one portion of a sheet. In the case of an ovoid preform containing rectilinear portions, for example, the portions of the transversal sheet in the curved portions may be fabricated according to the process of the present invention, while portions in the rectilinear area may be fabricated with parallel fiber elements of constant width.

In another embodiment of the present invention, a fabrication process for a preform comprises the steps of superimposing several fibrous sheets extending in different directions and binding together the superimposed sheets, wherein at least one portion of one of the sheets is fabricated as detailed above.

Preforms produced according to the present invention generally comprise (i) at least one sheet of fiber elements essentially parallel with each other and parallel to the longitudinal generator line (L) of the surface and (ii) at least one sheet of fiber elements that are not parallel to the longitudinal generator line shown in FIG. 1. Such preforms can, for example, contain (i) a first sheet of fiber elements 30₁ to 30ₙ extending along generally ovoid twists (in the case of an ellipsoidal preform) or concentric circles (in the case of an annular preform) deposited in a spiral, and referred to as a 0° strand sheet, (ii) a second sheet of fiber elements extending along directions secant to the strands of the first sheet, for example, along radial or centrifugal directions and presenting variable widths as described previously, and referred to as a 90° strand sheet, then (iii) another sheet of fiber elements extending along twists or circles, and (iv) a new sheet of non-parallel fiber elements, for example at +60°, −60°, +45° or −45°; and so forth until the desired thickness and shape are obtained. Other exemplary embodiments include preforms having shapes adapted for the fabrication of portholes.

Another exemplary embodiment of the present invention is a device for placing at least one fiber element on a surface wherein the device includes a component capable of manipulating and advancing a fiber element, a component capable of varying the width of the fiber element in its longitudinal direction, and a component capable of depositing the fiber element in a desired direction.

According to another embodiment, a device comprises a component capable of depositing a sheet of fiber elements on a surface along convergent directions, and a component capable of decreasing the width of the fiber elements in the direction of convergence where the width is decreased before deposition.

According to another embodiment, the width of the fiber element can be varied before deposition using device 20, which comprises a peripheral throat 21 formed in a cylindrical element 22 having a variable width. In particular, the width of the channel increases from value Eₐ to value E_{b} with a displacement inside the throat around the cylindrical element over half of the circumference of the cylinder, then the width of the channel decreases from value Eₐ to value E_{b} with a displacement over the other half of the circumference.

The device includes a component capable of feeding and advancing the fiber element through device 20 as defined above, which also makes it possible to adjust the fiber element's width. Such feeding and advancing components can, for example, comprise two rotating rollers such that the fiber element is passed between the rollers at the exit of device 20. A component capable of cutting the fiber element can also be provided at the exit of device 20 in order to allow the deposition of fiber elements in independent or discontinuous segments.

The deposition means can be implemented in any appropriate manner by various techniques well-known in the art.

According to another implementation embodiment, the installation can additionally include a device component capable of applying a binder on the deposited surface or on the fiber element itself.

Depending on the nature of the binder used, i.e., whether the binder is applied with the installation or not, the binder can also include a binder activation component (e.g., curing agent) that can be implemented by any appropriate method, such as a source of radiation like infrared, for example.

The installation includes a control unit that assures the control and synchronization of the different portions of the installation.

The following two examples illustrate the process according to the present invention.

A first example concerns the radial deposition of a 12K 880 Tex carbon strand on an annular porthole preform with an internal radius of 134 mm and an external radius of 215 mm. Such carbon strands have a width of 5-6 mm as they leave the spool. In this example, the deposited strand segments have a width which increases evenly from 2.45 mm to 3.93 mm while moving radially from the interior to the exterior of the preform, and the strand segments are deposited without overlap or gaps between the strands.

A second example concerns the radial deposition of a 12K 800 Tex carbon strand on a preform for a fuselage beam with an internal radius of 1,500 mm and an external radius of 1,600 mm. In this case, the deposited strand segments have a width which increases evenly from 4.13 mm at the internal radius to 4.41 mm at the external radius, so as to have no overlap or gaps between the strands.

If the two preceding examples are repeated using a 24K 1600 Tex strand instead of a 12K 800 Tex strand, all the strand width values are doubled.

1. A process for placing at least one fiber element on a surface, comprising the step of:
depositing at least one fiber element on the surface so as to form a deposited fiber element on at least one part of the surface, wherein a width of the deposited fiber element varies longitudinally along surface.

2. The process according to claim 1, wherein said depositing step comprises:
depositing a plurality of deposited fiber elements in non-parallel directions along surface, and wherein a width of each of the deposited fiber elements varies longitudinally along surface.

3. The process according to claim 2, wherein said deposited fiber elements are deposited in convergent directions, decreasing the width of each of said plurality of deposited fiber elements in a direction of convergence.

4. The process according to claim 2, wherein the width of each of the deposited fiber elements decreases proportionally to a distance separating middle fibers of two adjacent fiber elements.

5. The process according to claim 2, wherein said deposited fiber elements form an angle of 90°, +60°, −6°, +45° or −45° with a longitudinal line generator line of an object comprising surface.

6. The process according to claim 2, wherein no space or void exists between two consecutive fiber elements deposited on surface.

7. The process according to claim 2, wherein said deposited fiber elements are deposited as segments adjacent to each other over their entire length.

8. The process according to claim 2, wherein the surface on which said deposited fiber elements are deposited has an annular shape.

9. The process according to claim 1, further comprising the step of:
binding of the deposited fiber element to the surface by a chemical binder.

10. A fibrous sheet comprising two or more fiber elements extending in different directions, wherein at least one portion of said fibrous sheet is fabricated by the process of claim 2.

11. A process for the fabrication of a preform comprising:
superimposing several fibrous sheets of fiber elements extending in different directions, and binding together the superimposed fibrous sheets,
wherein at least one portion of one of the fibrous sheets is fabricated by the process of claim 2.

12. A fibrous sheet comprising a plurality of fiber elements extending in non-parallel directions, wherein a width of each of said fiber elements extending in non-parallel directions varies longitudinally.

13. The fibrous sheet according to claim 12, wherein said fiber elements extend in convergent directions and the width of each of said fiber elements decreases in the direction of convergence.

14. The fibrous sheet according to claim 12, wherein no space or void exists between two consecutive fiber elements.

15. The fibrous sheet according to claim 12, wherein said fiber elements comprise fiber segments adjacent to each other over their entire length.

16. The fibrous sheet according to claim 12, wherein said fiber elements are continuous strands comprising a set of 3,000 to 24,000 filaments.

17. The fibrous sheet according to claim 12, wherein said fiber elements are bound together by a chemical binder.

18. A preform comprising:
a superimposition of several fibrous sheets extending in different directions, and bound together,
wherein at least one of the fibrous sheets comprises the fibrous sheet of claim 12.

19. A composite material part comprising the fibrous sheet according to claim 12 and a thermoplastic or thermohardenable resin.

20. A device for placing at least one fiber element on a surface, said device comprising:
a component capable of controlling and advancing a fiber element,
a component capable of varying a width of the fiber element in its longitudinal direction, and
a component capable of depositing the fiber element in a desired direction.
